(19) United States
(12) Patent Application Publication
(10) Pub. No.: US 2013/0293143 A1
(43) Pub. Date: Nov. 7, 2013

(54) INTELLIGENT POWER SUPPLY SYSTEM

(71) Applicant: Harbor Industries, Inc., Grand Haven, MI (US)

(72) Inventors: Gregory Allen Hankamp, Holland, MI (US); Maurice Richard Fredricks, Grand Haven, MI (US); Bruce Allen Fredricks, Grand Haven, MI (US); Benjamin Tryon Fredricks, Grand Haven, MI (US); Raymond John Reeths, Grand Haven, MI (US)

(73) Assignee: HARBOR INDUSTRIES, INC., Grand Haven, MI (US)

(21) Appl. No.: 13/866,378

(22) Filed: Apr. 19, 2013

Related U.S. Application Data
(60) Provisional application No. 61/641,568, filed on May 2, 2012.

(51) Int. Cl. H02M 7/02; H05B 37/02

(52) U.S. Cl. CPC H02M 7/02; H05B 37/02
USPC 315/294; 307/17

(57) ABSTRACT

An intelligent power supply system includes a transformer and at least one gate unit. The transformer is configured to electrically connect to a higher voltage power source and to convert the higher voltage to a first reduced voltage. The transformer provides the first reduced voltage via a first output. The gate unit is operable to receive the first output and provide a second output at a second reduced voltage. At least one low voltage electrical device is electrically connectable to the second output. The transformer may electrically connect to a higher voltage power source at a first location, with the gate unit disposed at a second location remote from the first location, whereby the higher voltage power source is not at or near the second location, which may comprise a display location with various electrically powered display devices that are powered by the reduced voltage provided by the gate unit.

### CROSS REFERENCE TO RELATED APPLICATION

The present invention claims the filing benefits of U.S. provisional application, Ser. No. 61/641,568, filed May 2, 2012, which is hereby incorporated herein by reference in its entirety.

### FIELD OF THE INVENTION

The present invention relates generally to electronic power supply systems for powering various devices or accessories, such as at a display unit at a retail store, an office, a medical facility, a hospitality environment, an airport environment, a public transportation environment and/or the like.

### BACKGROUND OF THE INVENTION

Display areas typically include audible and/or visual presentations of information, such as information pertaining to products on a shelf, or to displays or exhibits in a museum or at a zoo, for example. In many cases, different electronic devices are disposed at or along the shelf or display area (such as for lights or display screens or the like). Often, the different electronic devices are powered by a low voltage power supply (such as 12 volts or 6 volts or the like), and often, the different electronic devices are powered by separate and different low voltage power supplies. Thus, the different electronic devices are powered by respective low voltage power supplies that are separately plugged into one or more 110 volt outlets at or near the display. Thus, multiple 110 volt lines and outlets may need to be established at the display area, in order to provide the desired power to various electronic devices at the display area.

### SUMMARY OF THE INVENTION

The present invention provides an information or display system that includes a power converter that converts 110 volt AC input power to a lower voltage DC output power (such as 12 volts or 18 volts or 24 volts or the like), whereby the lower voltage power is provided to a display area to power multiple electronic devices, and whereby different lower voltage levels may be provided (such as 12 volts, 9 volts, 6 volts, 5 volts, 3 volts and the like) to different electronic devices at the display area to provide the appropriate power supply to various electronic devices. The information or display system of the present invention thus provides various power supply voltages at a display area or work area or the like, without having to run or establish multiple 110 voltage lines and outlets at the display area or work area.

According to an aspect of the present invention, an intelligent power supply system includes a transformer configured to electrically connect to a higher voltage power source and to convert the higher voltage to a first reduced voltage. The transformer provides the first reduced voltage via a first output. A gate unit is operable to receive the first output and to provide at least one second output at at least one second reduced voltage (which is less than or equal to the first reduced voltage). At least one low voltage electrical device (such as a light or display screen or the like) is electrically connectable to the gate unit to receive the second output. The higher voltage may be at least about 110 volts, and the first reduced voltage may be at least about 18 volts and preferably no more than about 48 volts, and the second reduced voltage may be less than or equal to about 12 volts (such as 12 volts, 9 volts, 6 volts or 3 volts or the like).

Therefore, the present invention provides a low voltage power supply system for providing reduced voltage power to various locations and devices at a display unit or system or the like. For example, the power supply system may include a source box or transformer that is plugged into a standard 110 volt outlet, with an output (such as an 18 volt or 24 volt or the like output voltage) that is routed to a hub or gate unit or box that may be remote from the 110 volt outlet, such as at a display unit or the like. The routing of the reduced voltage line can be achieved via any suitable means and does not need to be done by a licensed electrician. The hub or gate box has one or more output lines for individually and separately powering various electrical devices or accessories, which may each be powered by the same or different reduced voltages (such as about 3 volts or 6 volts or 9 volts or 12 volts or the like). The present invention thus provides the desired or selected reduced voltages to the appropriate devices or locations to provide enhanced powering of accessories or devices, without requiring multiple 110 volt outlets and the like, and thus without requiring the services of a licensed electrician.

These and other objects, advantages, purposes, and features of the present invention will become apparent upon review of the following description in conjunction with the drawings.

### BRIEF DESCRIPTION OF THE DRAWINGS

FIG. 1 is a schematic of a low-voltage power supply system in accordance with the present invention;

FIG. 1A is a sectional view of the wiring taken along the line A-A in FIG. 1;

FIG. 1B is a perspective view of a gate box of the low-voltage power supply system of the present invention;

FIG. 2 is a perspective view of a low-voltage power supply system of the present invention;

FIG. 3 is an exploded perspective view of a display system of the present invention;

FIG. 4 is an exploded perspective view of another display system of the present invention;

FIG. 5 is an exploded perspective view of another display system of the present invention;

FIG. 6 is an exploded perspective view of another display system of the present invention;

FIG. 7 is a perspective view of another display system of the present invention;

FIG. 8 is a perspective view of another display system of the present invention;

FIG. 9 is a perspective view of another display system of the present invention;

FIG. 10 is a perspective view of another display system of the present invention; and

FIG. 11 is a perspective view of another display system of the present invention, shown in a residential application.

### DESCRIPTION OF THE PREFERRED EMBODIMENTS

The intelligent, low voltage power supply system of the present invention is operable to provide different low voltage power levels to power different devices for an information or display or lighting system, such as in a retail environment or residential environment or educational environment or office environment or medical facility or environment or hospitality environment or airport environment or public transportation environment and/or the like. The power supply system is operable to provide various power levels to a display area or the like to power various electronic devices in a safe and efficient manner, without requiring installation of costly 110 v power lines and outlets, as discussed below. The power supply system may provide intelligent supply of power and may be responsive to sensors or the like so as to activate or power the electronic devices when it is determined that a person or consumer is at the display area, as also discussed below.

Currently, there is not a cost-effective and simple solution for delivering power to the shelves of a display area, such as for powering lights or display devices or the like. The delivery of power is often a major hurdle in the implementation of digital media or lighting at the shelf edge (because typically a 110 voltage line and outlet must be run to the display area, which requires planning and which must be installed by an electrician). The solution to this problem is a low-cost network of low-voltage lines that stem from a power supply connected to a pre-existing 110 v outlet (that may be at or near to or remote from the display area). Multiple low-voltage lines of various outputs (such as, for example, 12 v, 9 v, 5 v, USB, and/or the like) are regulated by converter boxes. These boxes may be electrically connected or “daisy chained” to provide the user with more outputs at the display area (without having to run more 110 volt power lines and outlets). The system can be incorporated into new or existing retail environments or other spaces outside of the retail environment (such as, for example, a residential system that integrates with existing 110 v household wiring). Optionally, the power supply system may be provided modularly (such as with a selected number of gate boxes and selected length of wiring between gate boxes), such as for use on one or more retail “gondolas” or modular retail display racks having multiple shelves.

With the power supply system of the present invention, the consumers benefit because the retail spaces may be more entertaining, informing, and dynamic, thereby creating a positive experience for consumers (because a variety of electronic devices, each potentially requiring a different low voltage power supply, may be readily provided at the display area or retail space). The retailers also benefit because the power supply system of the present invention provides a low-cost system (a typical 110 v supply is costly to install at or on the display, and the low power system will be at much lower cost, such as about half the cost of a 110 v power supply), and the power supply system of the present invention may be installed by a user or employee of the retailer (a 110 v power run or drop to a display requires a licensed electrician to install, while the low voltage system can be installed by existing staff members, and is merely plugged into an existing 110 v power outlet that may be remote from the display), and the power supply system of the present invention is efficient (a 24 v or 18 v or 12 v power supply draws much less current than 110 v, saving on operations). The power supply system of the present invention may also provide power to the shelf edge to deliver power to the shelf edge accessories (a 110 v power supply and outlet is not typically at locations where customers can touch the outlet for safety reasons).

The power supply system of the present invention is also flexible, and the system can be readily configured, reconfigured, repurposed, modified and/or moved, without having to hire an electrician or the like. Although primarily targeted for retail environments, such as at display shelves and the like, the power supply system of the present invention is suitable for various other environments or applications, including residential applications (where the power supply system may provide different power levels for lights, computers, electronic chargers and/or the like), healthcare applications (where the power supply system may provide different power levels for lights, display devices and the like at an office environment to provide information to the patients) and/or other office environments or applications and/or educational or informational environments or applications (such as at a school or museum or the like), while remaining within the spirit and scope of the present invention.

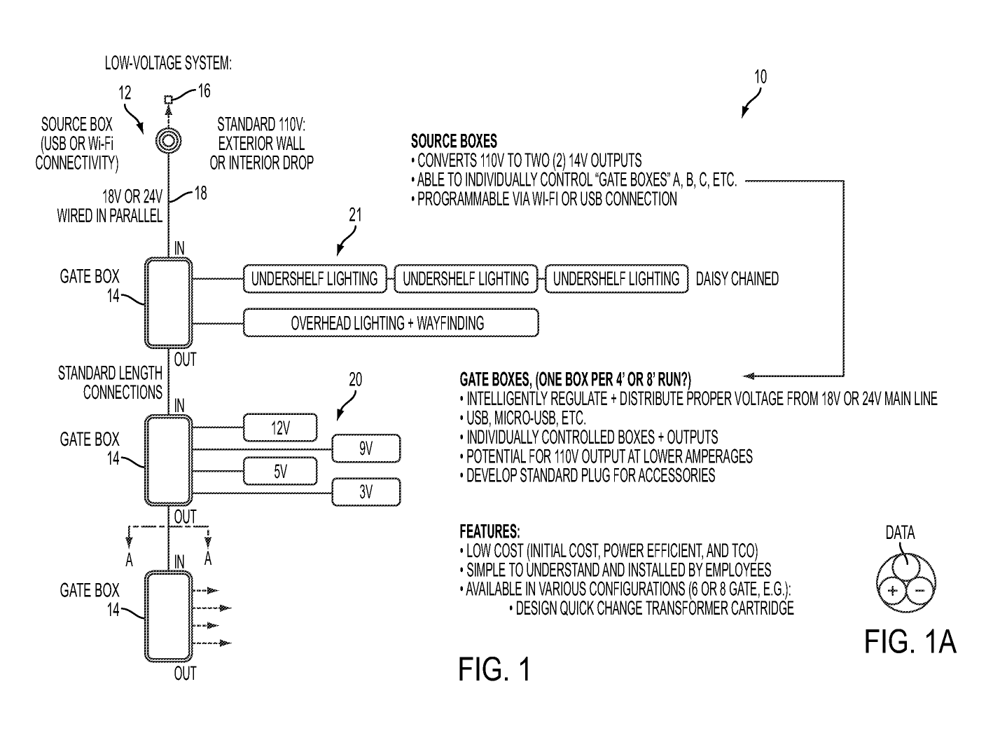

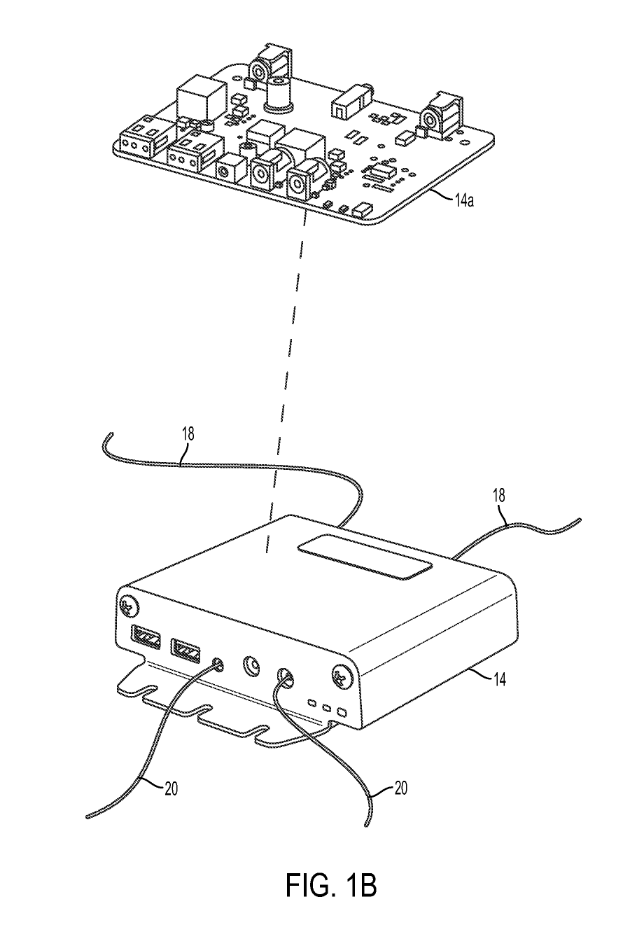

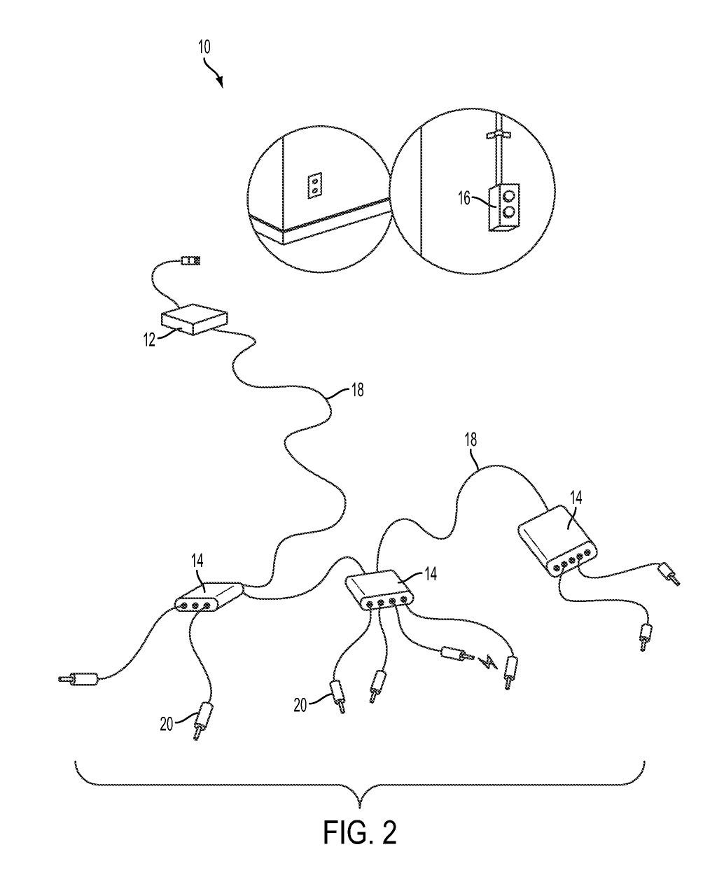

Referring now to the drawings and the illustrative embodiments depicted therein, and as shown in FIG. 1, a power supply system 10 includes a source box 12 and a plurality of gate boxes 14. The source box 12 is electrically connected to (or plugged into) a conventional 110 volt outlet 16 and is operable to convert the 110 v input (delivered by the outlet 16) to one or more lower voltage outputs 18 (such as one or more 14 volt outputs or 18 volt outputs or 24 volt outputs or the like). The source box or unit thus may be powered via 110 volts AC (or other higher voltage power source, such as 220 volts), and includes a transformer or DC converter, which converts the input power to a selected stepped down or reduced voltage (such as 12 volts DC or 18 volts DC or 24 volts DC or 48 volts DC or any suitable voltage for the particular application of the power supply system). Optionally, the source box may have a USB or Wi-Fi connection, and may be remotely programmable to provide the desired or appropriate functions. The source box output 18 powers the gate box or boxes 14, and the voltage outputs of the output line 18 may be wired in parallel so as to provide individual control over different gate boxes, if desired.

The output 18 (which may include power and data lines, such as shown in FIG. 1A) from the source box 12 is thus provided to one or more gate boxes 14, which in turn provide selected or appropriate low voltage outputs 20 for various electronic devices 21 (such as lights, display elements, user interactive devices and/or the like). For example, the gate boxes 14 may include one or more transformers or converters or circuitry 14a (such as at a circuit board or element of the box, such as shown in FIG. 1B) that receive the stepped down DC voltage from the source box and provide selected various low voltage outputs (such as, for example, 3 volts, 5 volts, 6 volts, 9 volts and/or 12 volts and/or the like), such as for powering lights and/or display devices (such as display screens that may display still images or video images or the like) and/or other electronic devices at the display area. The gate boxes 14 may be provided at different selected areas at or along a display area so that the display devices can readily plug into or electrically connect to the appropriate output of the gate box. The gate boxes receive the 18 volt or 24 volt main line voltage (or other suitable stepped down voltage) and may intelligently regulate and distribute the appropriate or proper voltage to the various devices or outlets or ports. Optionally, it is envisioned that the gate boxes may provide a 110 volt output at a lower or reduced amperage. The gate boxes may have multiple transformers to receive the input voltage and provide the desired respective output voltage to one or more ports of the gate box. The gate boxes may have various outlets or ports for connection of the various electronic devices, such as, for example, USB ports, micro-USB ports, and/or the like, and may provide a standard outlet or connector for a universal or standard device plug or accessory plug. The gate boxes may comprise individually controlled boxes that individually provide the voltage outputs to the respective devices or accessories.

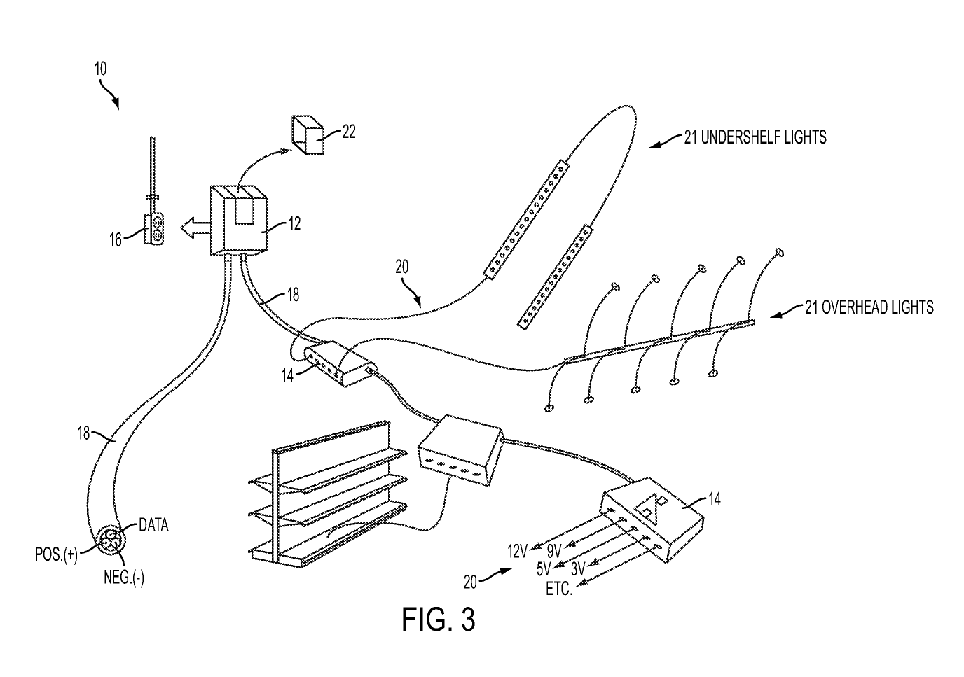

The power supply system of the present invention thus provides a low cost system (with reduced initial set up and installation cost, and increased power efficiency), which is easy to understand and which may be readily installed by employees (and does not require licensed electricians to install). The power supply system may be provided in various optional configurations to adapt the system to the particular application or display environment. Optionally, the source box may have an interchangeable transformer or transformer cartridge 22 (FIG. 3) that may be readily selected and installed (such as by snapping or plugging the cartridge into the source box) to quickly adapt or re-configure the source box to provide the desired transformer that provides the desired or selected stepped down voltage or voltages to the output or outputs of the source box, depending on the particular application of the source box and the particular gate boxes and/or accessories or devices that are to be powered by the particular source box (and optionally, the gate boxes may have similar selectable and interchangeable transformer cartridges to readily and selectably configure or reconfigure the gate boxes for various applications and output voltages).

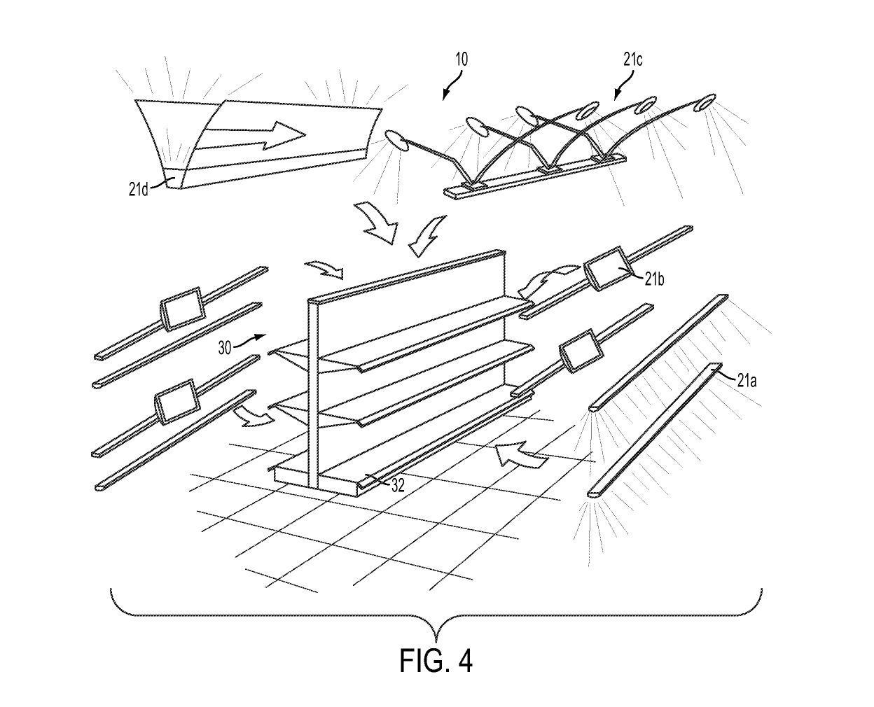

The power supply system of the present invention may be installed or implemented at any display area or work area or other areas where various power supplies may be desired. For example, and with reference to FIGS. 4-8, the power supply system 10 may be implemented at a retail shelving unit or display unit 30 to provide power to various devices or accessories at and along the shelves 32 of the display unit 30. For example, the source box 12 may be remote from the display unit 30 and may be plugged into a standard, already existing 110 volt outlet 16 (which may be at a wall or column of the facility and at or near or remote from the display unit 30), and the output 18 (such as a wire or cord or the like) of the source box may be routed to the display unit via any suitable means (such as in the ceiling of the retail store and dropped down to the display unit or in the floor or along the walls of the store, since such low voltage wiring does not have the code requirements for routing that 110 voltage wire has), where it is connected to one or more gate boxes 14.

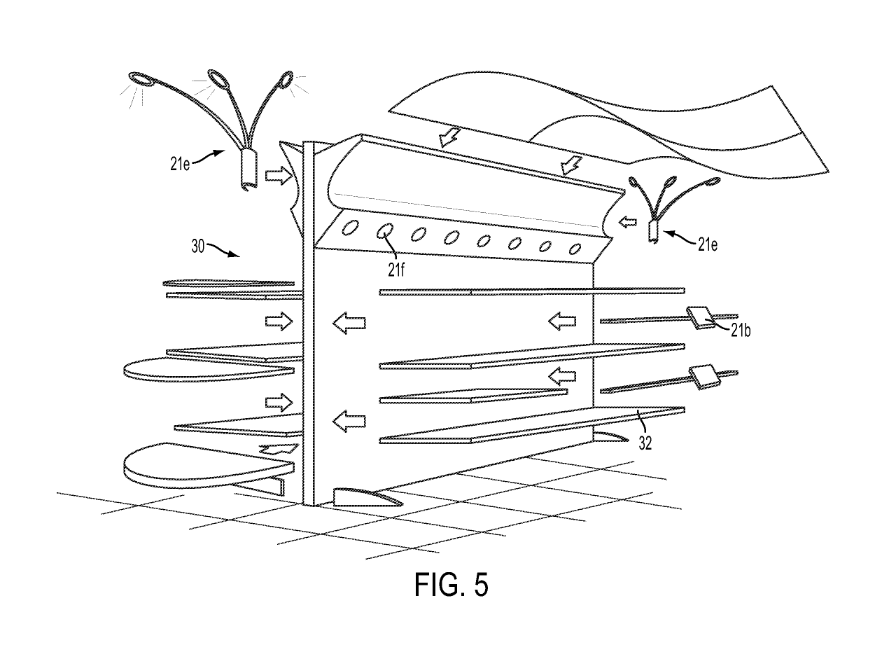

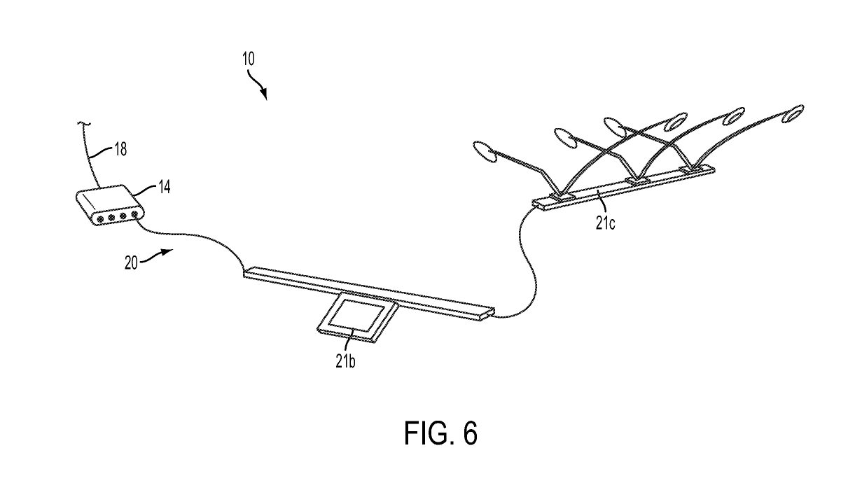

The gate box or boxes 14 may be located at suitable locations at the display unit to provide the selected or appropriate power to the various devices or accessories of the display unit. For example, a gate box may be disposed at one or more of the shelves 32 (such as a standard shelf unit or gondola) and may provide an outlet strip along the shelf, whereby under-shelf lighting 21a (FIG. 4), such as under-shelf light emitting diodes (LEDs) may be readily plugged into the outlet or outlet strip of the gate box, and/or one or more user interface devices 21b (such as a movable user interface device of the types described in U.S. patent application Ser. No. 12/582,124, filed Oct. 20, 2009 for MOVABLE INTERACTIVE INFORMATION SYSTEM, which is hereby incorporated herein by reference in its entirety) and/or the like. Optionally, a gate box may be disposed at or connected to an upper track of the display unit, whereby overhead lighting 21c (such as overhead LED lighting) may be plugged into or connected to the gate box outlet port and/or wayfinding signage and/or backlit signage 21d may be plugged into or connected to the gate box outlet port, and/or end lighting 21e (FIG. 5) may be plugged into or connected to the gate box outlet port, and/or other types of lighting 21f (FIG. 5) may be plugged into or connected to the gate box outlet port, and/or the like. As shown in FIG. 6, the various power supplies (such as 9 volt or 12 volt or the like) provided by the gate box 14 (which may be powered via a 18 volt or 24 volt lead or the like) may be provided in series or “daisy chained”, or optionally, multiple gate boxes may provide multiple outlets to various accessories (and optionally at the same or different low voltage power, depending on the particular application).

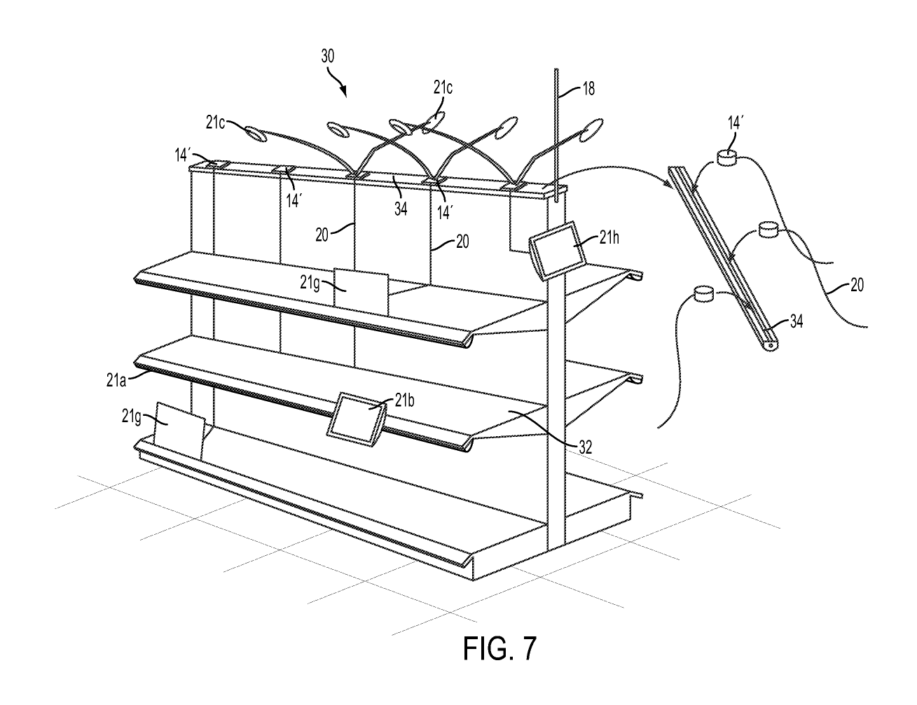

Optionally, the power supply system may include powered tracks or quick connect elements (such as a track disposed along an upper end or cap of the display unit) such that the device or accessory (such as overhead lighting or the like) may be readily snapped into or onto the track (whereby electrical connection is made when the accessory is mechanically snapped or attached to the track) to electrically connect the light or accessory to the gate box. For example, and with reference to FIG. 7, the source box output 18 may be connected to a power track 34, which may, for example, be disposed along an upper cap of the display unit 30, whereby the 18 volt or 24 volt (or other selected voltage) may be provided along the power track. As shown in FIG. 7, the rail or track 34 is accessible so that one or more gate boxes or “power pucks” 14′ may be clipped into or snapped onto the rail or track 34 to electrically connect to the source box output 18, whereby each gate box or power puck 14′ provides the appropriate power (such as 3 volts or 6 volts or 9 volts or 12 volts or the like) to various accessories, such as, for example, overhead lighting 21c or the like. As also shown in FIG. 7, the gate boxes 14 may provide output leads 20 (at the desired reduced voltage or voltages) that are routed to various devices at the shelves 32 of the display unit 30, such as to digital signage 21g or other signage 21h (such as wayfinding signage or the like) at one or more of the shelves or at the end of the display unit or to the track of a movable user interface device 21b or the like. Thus, various low or reduced voltages may be supplied at various locations of the display unit, with the gate boxes being powered by a reduced voltage supply feed 18 (such as 18 volts or 24 volts or the like that is provided by the source box that is plugged into a standard outlet remote from the display unit), so that the reduced voltage line or lines can be installed without need of a licensed electrician.

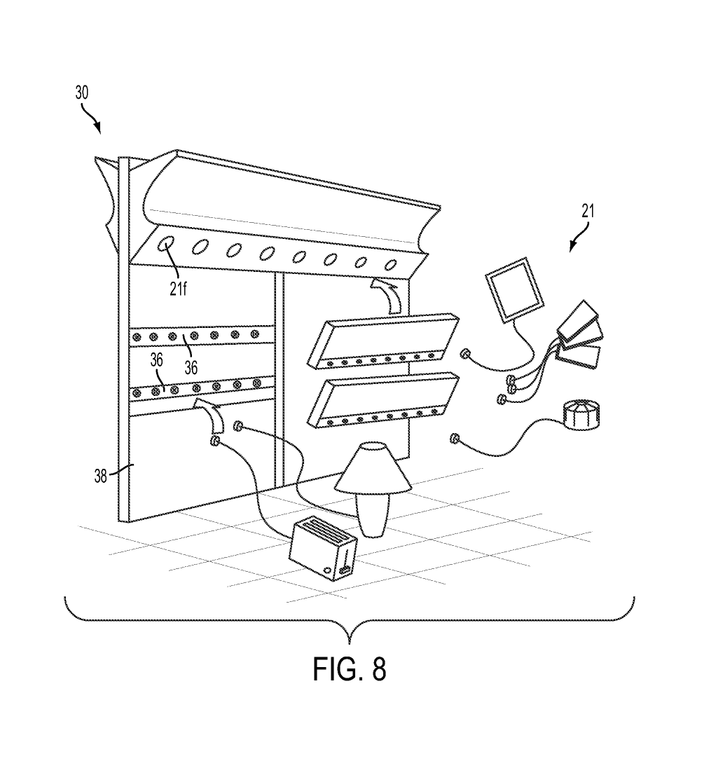

Optionally, and as shown in FIG. 8, the power supply system 10 may provide one or more plug in strips 36 having various low voltage outlets or ports at a wall 38 of a display unit 30, such that various accessories or devices 21 may be plugged into the outlets or ports of the strips 36 to provide the desired display appearance and function. In the illustrated embodiment, various low voltage accessories are shown at the display unit 30 and may be plugged into the appropriate low voltage outlets (which may provide the same or different voltage outputs).

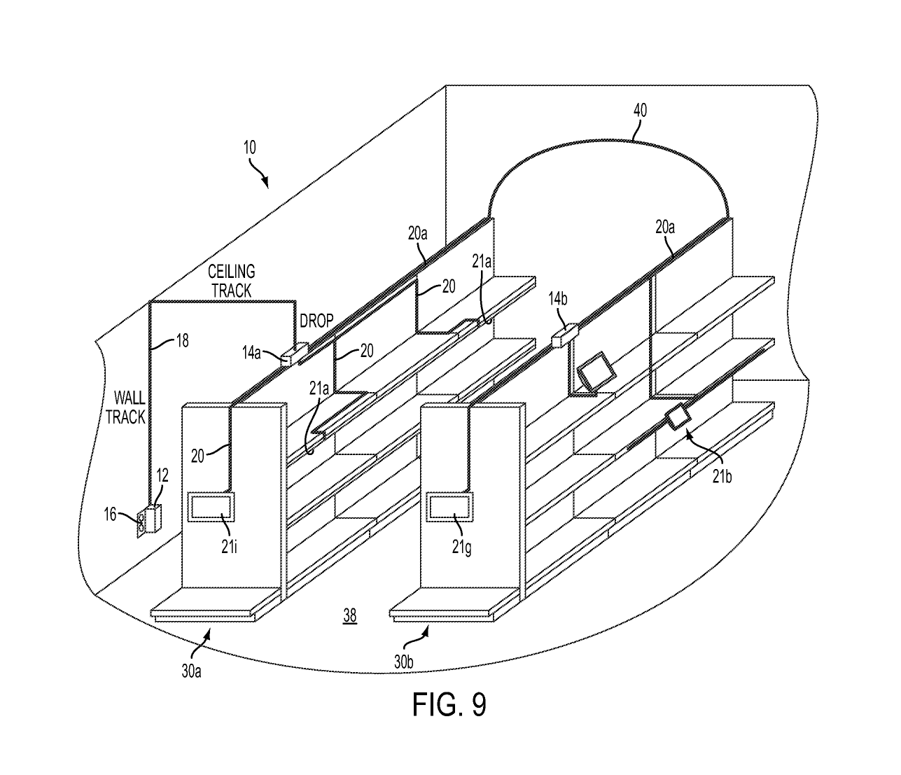

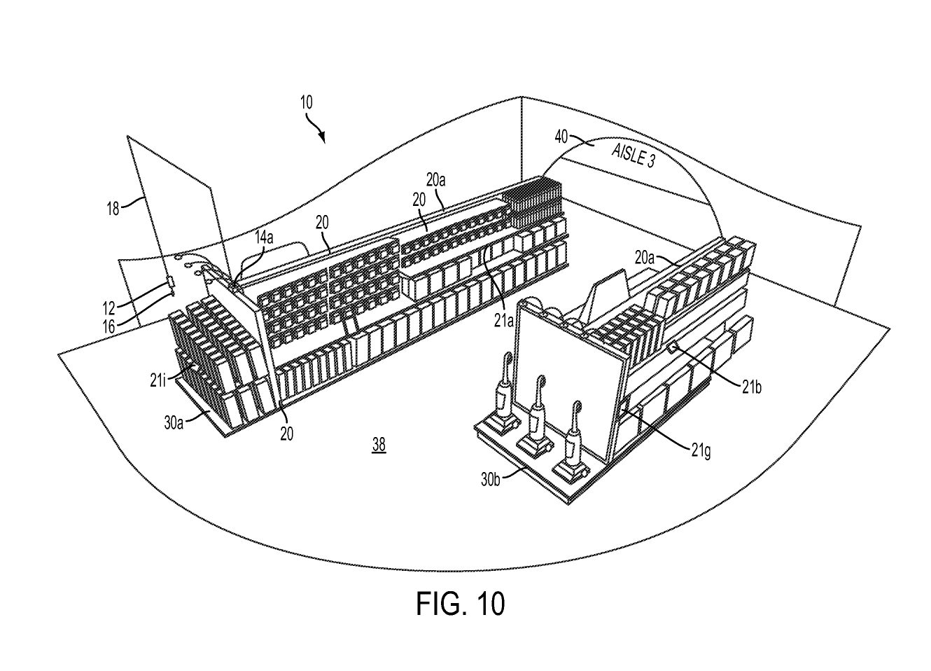

Thus, the present invention provides a low voltage power supply system for providing reduced voltage power to various locations and devices at a display unit or system or the like. For example, and with reference to FIGS. 9 and 10 (showing similar examples of the various electrically powered devices that can be powered by the power supply system of the present invention), the power supply system 10 includes a source box or transformer 12 plugged into a standard 110 volt outlet 16, with an output 18 (such as an 18 volt or 24 volt or 48 volt or the like output voltage) that is routed along a wall of the store room or facility and along the ceiling, where it may be dropped down to a first hub or gate box 14a at an upper region of a display unit 30a. The output line 18 may be disposed in a wall track and ceiling track and need not be within the wall and ceiling of the facility. As shown in FIGS. 9 and 10, the first hub or gate box 14a has output lines 20 for individually and separately powering an interactive device or price scanner 21i and under shelving lights 21a at the first display unit 30a.

Another output line 20a of first hub or gate box 14a may be routed along the display unit 30a and across an aisle 38 to another display unit 30b via a bridge 40 (such as a tube or conduit that is curved to provide an aisle bridge and to provide clearance below for people to walk along the aisle between the display units). Again, because the output line 20a provides low voltage, the bridge 40 may comprise any suitable conduit (and need not meet the restrictions and codes that are applied to 110 voltage wires and the like). The output line 20a electrically connects to a second hub or gate box 14b at display unit 30b, and the second hub or gate box 14b provides output lines 20 that electrically power various accessories, such as signage 21g, user interface devices 21b and/or the like. Although not shown in FIGS. 9 and 10, further output lines may be provided from either hub and may be routed to other display units at the facility (such as via aisle bridges or the like), to provide power to various accessories or devices at different display units or different locations at the facility or store.

Optionally, one or more of the hubs or gate boxes may be operable to provide power responsive to a sensor or user input or the like. For example, a motion sensor or proximity sensor or infrared sensor or laser sensor or the like may be disposed at or near a display unit to detect the approach and/or presence of a person at the display unit. The gate box, responsive to receipt of a signal from the sensor that is indicative of a person approaching or at the display unit, may activate or power the power outlet lines of the gate box, whereby the accessories are powered. Such a configuration allows the intelligent power supply system of the present invention to power the accessories (such as lights, displays, user interactive devices and the like) only when a consumer or user is present, and the gate box may deactivate when (or a period of time after) a person is no longer detected at or near the display unit, in order to save power by not constantly powering the accessories.

Although shown and described as being implemented at one or more display units, such as for a retail store or the like, it is envisioned that the power supply system of the present invention may be implemented in various environments where different low voltage devices or accessories are used or operated. For example, the power supply system may be used for educational purposes, where the system may provide power to various interactive teaching or learning devices and/or informational display devices or the like, or may be used at museums or the like, where different display devices and/or interactive display devices may provide information about the items displayed at or near the device. The system may thus be used for any type of display or lighting construction or the like, such as a display at a retail store, an office, a medical facility, a hospitality environment, an airport environment, a public transportation environment, a residential or household environment and/or the like, where the construction may be used and powered to provide the desired electrically powered display devices or lighting devices or user input devices or the like, and where the devices may operate at different power supply levels (such as different voltages), whereby the system of the present invention provides the appropriate power supply for the different devices, all via a single electrical connection at a source of power, such as a 110 volt outlet or the like, which may be remote from the display construction.

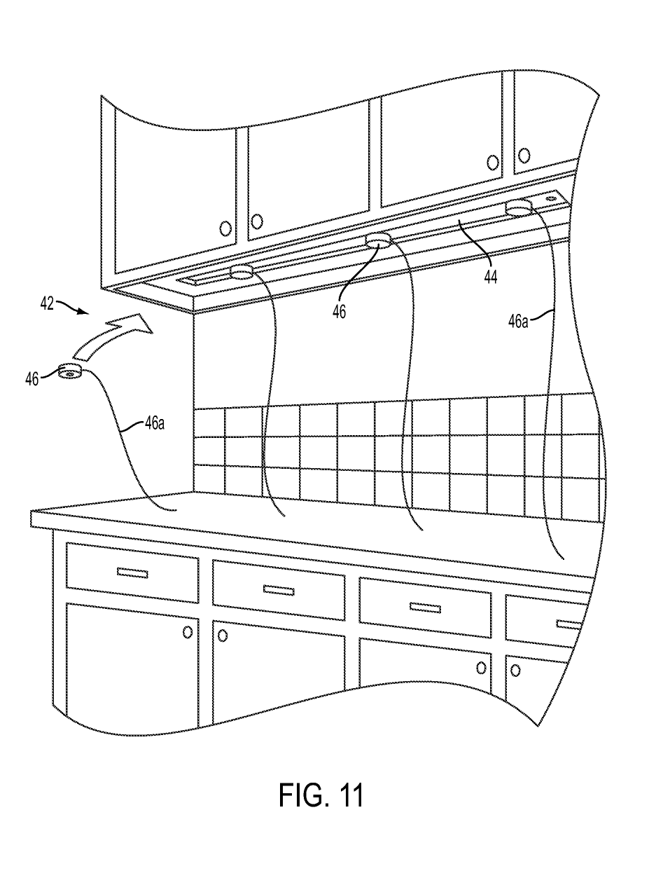

Optionally, the power supply system may be implemented in a residential environment or application. For example, and with reference to FIG. 11, a power supply system 42 may include a transformer or source box that is plugged into or electrically connected to a 110 volt power source, whereby an output (such as a 12 volt output or 18 volt output or 24 volt output or the like) is electrically connected to a power track 44, which may be mounted along an underside of a kitchen cabinet or the like. In the illustrated embodiment, one or more power pucks 46 may be snapped or clicked into the track 44, and may provide the desired or appropriate voltage outputs 46a for electrically connecting to an appropriate device or accessory. The power pucks 46 may provide a further stepped down voltage (that is lower than the voltage at the power track), such as in a similar manner as the gate boxes discussed above. For example, one power puck may provide or power an under cabinet lighting function, while another may provide a desired voltage and amperage for charging a cell phone or the like, and another may power a computer or laptop or the like. The power pucks may be selected (such as by the consumer) to provide the desired or appropriate output or outputs for the particular application of the system and desired powering of selected devices or accessories.

The intelligent low voltage power distribution system of the present invention thus provides clean regulated multi-voltage power to multiple electronic devices from a single power source (such as from a single 110 v outlet). The distribution board provides support for different voltage powered devices (such as, for example, 12 volt devices, 9 volt devices, 6 volt devices, 5 volt devices and/or 3.5 volt devices and/or the like). The system includes updateable on-board intelligence to support external passive infrared sensors (PIR sensors) used to manage power by detecting when a person is at or near or approaching the display area. The system can be extended by adding additional distribution boards to the low voltage network. All of the distribution boards include in and out ports for the distribution of power and data throughout the system. The system of the present invention thus provides intelligent power management of outgoing current with use of sensors, and provides on board intelligence to facilitate the flow of data and communications with tracking hardware such as cameras, sensors and gesture recognition devices. The system may also be reconfigured or selectively changed, such as via changing a transformer card to select a desired voltage output for one or more of the distribution boards and/or gate boxes.

Thus, the intelligent power supply system of the present invention provides multiple voltage outputs (such as, for example, 12 volts, 9 volts and/or 5 volts and/or the like) and provides regulated voltage output to all of the devices or accessories. The power supply system provides filtered (clean) power and may provide a built-in overload protection. The power supply system may also provide for the intelligent power management of outgoing current by use of sensors (such as motion sensors or proximity sensors or the like). The power supply system of the present invention provides an adaptable architecture for additional device support, and may provide on-board memory modules for feature upgrades. Optionally, the power supply system may include one or more communication ports to connect several units with a single wireless connection, in order to enhance control of the system and power supplies.

Changes and modifications to the specifically described embodiments may be carried out without departing from the principles of the present invention, which is intended to be limited only by the scope of the appended claims as interpreted according to the principles of patent law including the doctrine of equivalents.

1. An intelligent power supply system comprising:
a transformer configured to electrically connect to a higher voltage power source and to convert the higher voltage to a first reduced voltage, said transformer providing said first reduced voltage via a first output;
at least one gate unit operable to receive said first output and to provide at least one second output at at least one second reduced voltage; and
wherein at least one low voltage electrical device is electrically connectable to said second output.

2. The intelligent power supply system of claim 1, wherein said higher voltage comprises 110 volts.

3. The intelligent power supply system of claim 1, wherein said first reduced voltage comprises one of about 18 volts and about 24 volts.

4. The intelligent power supply system of claim 1, wherein said at least one second reduced voltage comprises at least one of about 3 volts, about 3.5 volts, about 5 volts, about 6 volts, about 9 volts and about 12 volts.

5. The intelligent power supply system of claim 1, wherein said higher voltage is at least about 110 volts and wherein said first reduced voltage is at least about 18 volts and no more than about 48 volts and wherein said second reduced voltage is less than or equal to about 12 volts.

6. The intelligent power supply system of claim 1, wherein said at least one gate unit comprises a plurality of gate units.

7. The intelligent power supply system of claim 1, wherein said at least one second output comprises at least two second outputs and wherein said second outputs provide different second reduced voltages.

8. The intelligent power supply system of claim 1, wherein said transformer is reconfigurable via a cartridge that is removable and replaceable to adjust said first reduced voltage to a selected voltage.

9. The intelligent power supply system of claim 1, wherein said first output electrically powers a power track, and wherein said at least one gate unit is configured to mechanically attach to a selected location along said power track and wherein said at least one gate unit makes electrical connection to said first output when said at least one gate unit is attached to said power track.

10. The intelligent power supply system of claim 9, wherein said at least one gate unit snaps to said power track.

11. The intelligent power supply system of claim 1, wherein said at least one gate unit is operable to provide said second output responsive to an input.

12. The intelligent power supply system of claim 11, wherein said input comprises an input from a sensor that is operable to detect the presence or approach of a person at or near said at least one gate unit.

13. The intelligent power supply system of claim 1, wherein said transformer is electrically connected to the higher voltage power source at a first location and wherein said at least one gate unit is disposed at a display location remote from said first location, and wherein said at least one gate unit receive said first output via a reduced voltage wiring.

14. A display system for powering a plurality of display devices at a display, said display system comprising:
a transformer that electrically connects to a higher voltage power source at a first location, said transformer converting the higher voltage to a first reduced voltage, said transformer providing said first reduced voltage via a first output;
a plurality of display devices at a display at a second location that is remote from said first location, wherein said plurality of display devices comprise low voltage electrically powered devices;
at least one gate unit disposed at said second location and operable to receive said first output and to provide a plurality of second outputs at at least one second reduced voltage; and
wherein said plurality of display devices are electrically connectable to said second outputs.

15. The display system of claim 14, wherein said at least one gate unit comprises a plurality of gate units, and wherein a first gate unit of said plurality of gate units provides a second output that is greater than a second output of a second gate unit of said plurality of gate units.

16. The display system of claim 15, wherein said first output is provided at said second location via a power strip disposed at said second location, and wherein said first and second gate units are selectively connected to said power strip.

17. The display system of claim 14, wherein said plurality of display devices comprise at least one of (i) a light, (ii) a display screen and (iii) a user interactive device.

18. The display system of claim 14, wherein said transformer is reconfigurable via a cartridge that is removable and replaceable to adjust said first reduced voltage to a selected voltage.

19. The display system of claim 18, wherein said at least one gate unit is reconfigurable via a cartridge that is removable and replaceable to adjust said second reduced voltage of said second output to a selected reduced voltage.

20. A display system for powering a plurality of display devices at a display, said display system comprising:
a transformer that electrically connects to a higher voltage power source at a first location, said transformer converting a higher voltage of said higher voltage power source to a first reduced voltage, said transformer providing said first reduced voltage via a first output;
wherein said higher voltage is at least 110 volts and wherein said first reduced voltage is at least about 18 volts and no more than about 48 volts;
a plurality of display devices at a display at a second location that is remote from said first location, wherein said plurality of display devices comprise low voltage electrically powered devices and wherein said low voltage electrically powered devices comprise at least one of (i) a light, (ii) a display screen and (iii) a user interactive device;
first and second gate units disposed at said second location and operable to receive said first output and to provide a respective second output at respective second reduced voltages;
wherein said second reduced voltage of said first gate unit is different from said second reduced voltage of said second gate unit, and wherein said second reduced voltage of said first gate unit is less than about 24 volts and said second reduced voltage of said second gate unit is less than about 12 volts; and
wherein at least one of said plurality of display devices is electrically connectable to said second output of said first gate unit and at least one other of said plurality of display devices is electrically connectable to said second output of said second gate unit.

21. The display system of claim 20, wherein said transformer is reconfigurable via a cartridge that is removable and replaceable to adjust said first reduced voltage to a selected voltage.

22. The display system of claim 20, wherein said at least one gate unit is reconfigurable via a cartridge that is removable and replaceable to adjust said second reduced voltage of said second output to a selected reduced voltage.
